(19) United States
(12) Patent Application Publication
(10) Pub. No.: US 2004/0019525 A1
(43) Pub. Date: Jan. 29, 2004

(54) Integrated restaurant operating system using events wherein the event is compared to the standard

(76) Inventors: William E. Kish, Moraga, CA (US); Willard Thomas Price, Stockton, CA (US); Ramesh Saligrama Krishnamurthy, Stockton, CA (US); John Michael Evey, San Diego, CA (US); Thomas Edward McCarty, Oakland, CA (US)

Correspondence Address: William E. Kish, 1738 St. Andrews Drive, Moraga, CA, 94556, US

(21) Appl. No.: 10/208,316

(22) Filed: Jul. 29, 2002

(51) Int. Cl. G06F 17/60

(52) U.S. Cl. 705/15

(57) ABSTRACT

The IRO System entitles employees to communicate change of restaurant events compared to established restaurant standards. Employee empowerment is created wherein the employee has responsibility for reporting the variance to the standard daily within his or her work shift. The reporting represents empowerment wherein the change is recorded and updated in the database within the work shift. The restaurant industry has adopted food and beverage controls for the collection and recording of food and beverage receipts, and production. This invention improves productivity by identifying and recording events by employees.

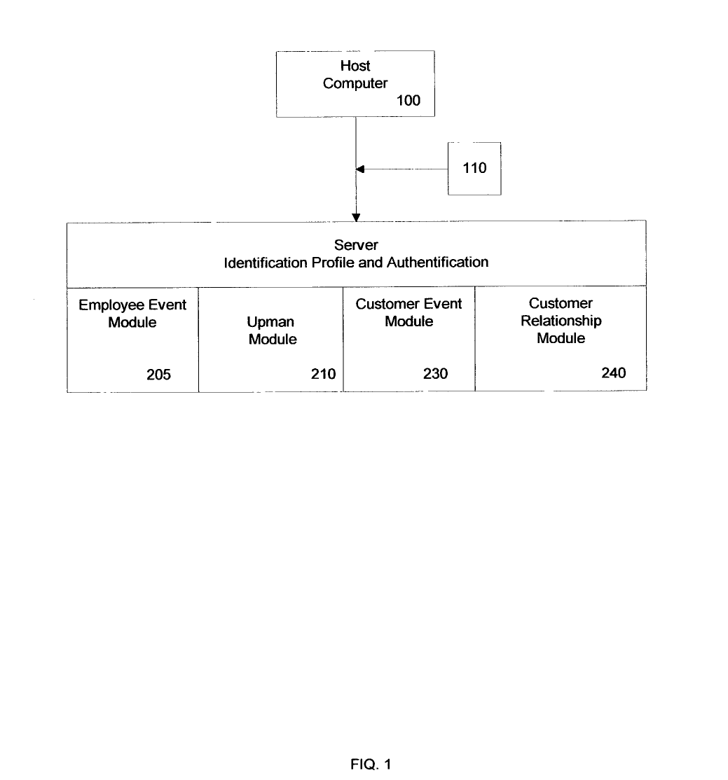

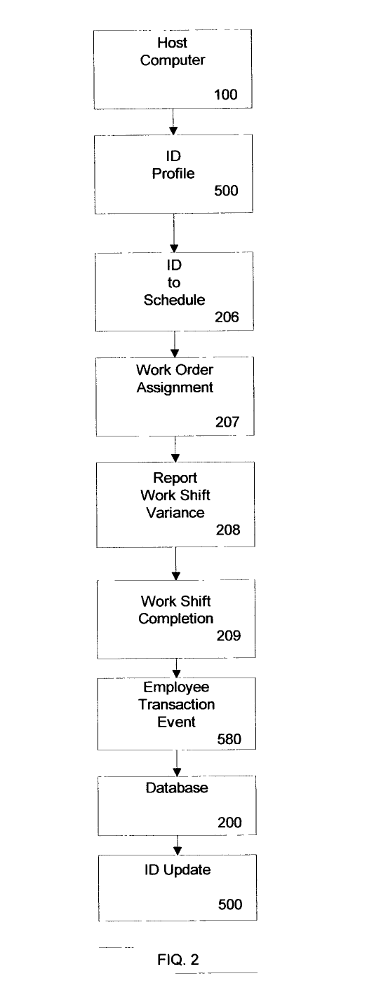

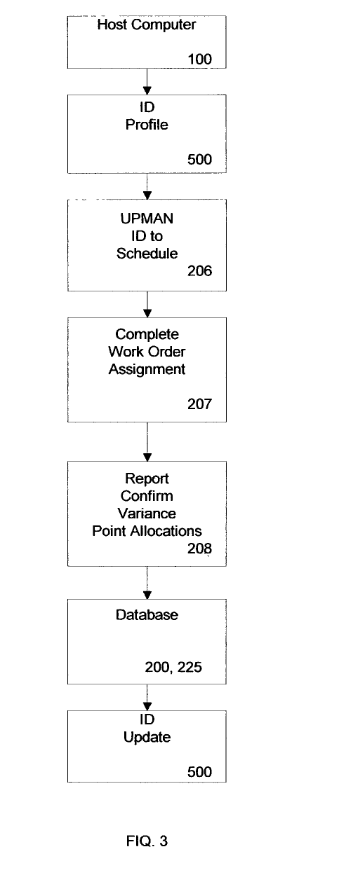

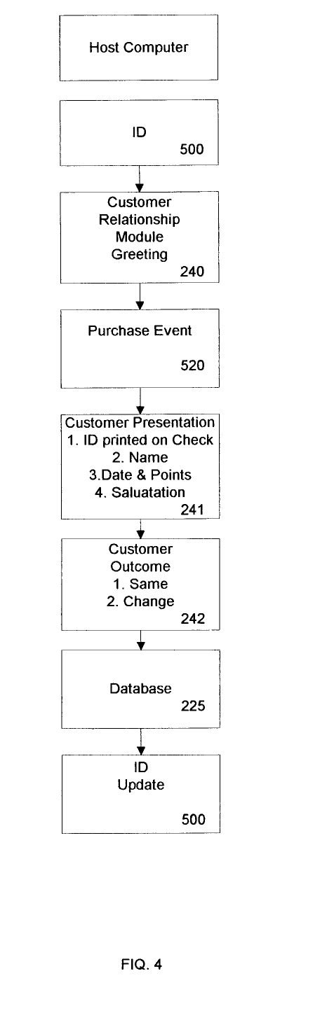

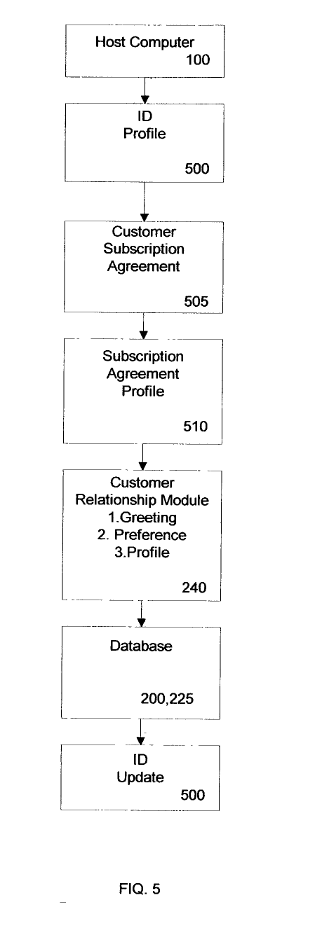

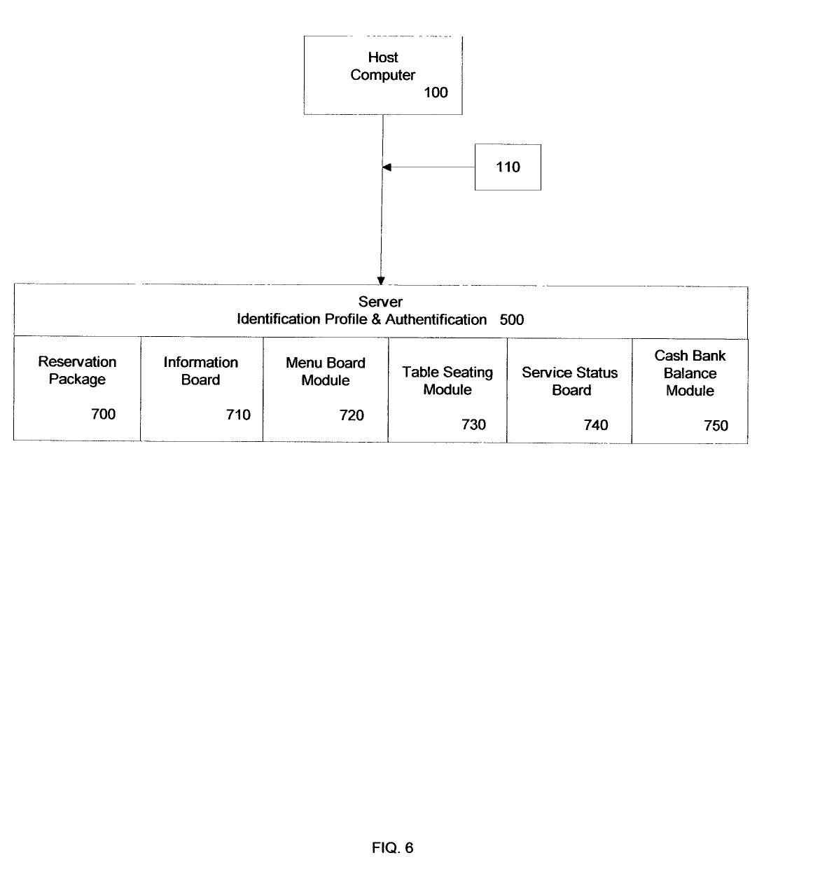

### FIELD OF TECHNOLOGY

The present invention empowers employees in restaurants. The IRO System is a method of operation that can be used to improve employee productivity and customer loyalty, as well as the operating efficiency and, consequently, the profitability of restaurants.

### BACKGROUND OF THE INVENTION

In the traditional restaurant environment, the restaurant manager serves customers by managing reservations and scheduling, training and supervising personnel. The host or hostess greets and seats the customers and collects payment. A restaurant company currently spends a considerable portion of its payroll to ensure customer satisfaction. The IRO System reduces or eliminates the need for these levels of management through employee empowerment and incentive programs.

In today's restaurant environment, “management” is by definition the general manager, manager and assistant manager as well as the host or hostess for customer flow control. Together they provide reservation services, provide the location of and directions to restaurant, welcome customers, assign seating, escort customers, present menus, announce the waitperson's name, and schedule and provide assignments for restaurant employees. With the IRO System, the information provided through the Information (Welcome) Board and the employees who wait tables cover all these functions and responsibilities.

In today's management-intensive restaurant systems, the managers decide how to respond to customer requests and complaints. With the IRO System in place, the employees hold the responsibility for determining how to respond to requests and complaints.

Management in today's restaurant environment identifies current and future patron service requirements. The IRO System provides the tools through which employees maintain personal contact with their assigned customers. Employees are not only permitted, but also actually encouraged to contact customers to maintain and extend the customer relationship by the use of email, fax and phone.

Management in today's restaurant environment recruits, orients and trains employees. Restaurant manuals are published and the buddy system is briefly used through which new recruits observe and are advised by trained employees. The IRO System provides incentives for employees to help new employees become productive for the company. Productivity rewards, earned by the employees for various activities that enhance their personal productivity and the productivity of the restaurant, are issued in points that are convertible for equity, cash bonuses or special award items.

Management in today's restaurant provides coaching, counseling, monitoring and appraisal of job performance and, if needed, initiates disciplinary action. The IRO System creates, through employee empowerment, a management structure through the appointment of a waitperson to the post of “Upman”. The Upman has become qualified through his or her experience and accomplishments to make restaurant management decisions. The Upman is provided with additional productivity awards.

The IRO System empowers the Upman. He or she has responsibility for enforcing alcohol control practices, maintaining sanitation procedures, maintaining first aid, CPR and Heimlich maneuver certification, approving schedule changes and achieving restaurant revenue goals.

The collection of revenue has improved greatly in recent years. Today's systems of revenue collection and cash management produce input that assists considerably in the process of controlling restaurant food and beverage costs. Cost controls are very important if a restaurant is to assure high operating margins. Good revenue collection and cash management systems also make it harder for dishonest employees to steal sales revenue. Employee theft of sales revenue, food, beverage and supply inventory, however, continues to be a significant concern. The IRO System provides the identification of inefficient employees by statistical charting and by daily reviews from the Upman.

The IRO System provides the incentive for employees to improve the financial performance by marketing, managing and accounting for his or her own work shift.

The restaurant industry often provides a person's first labor experience. The industry employs part-time employees to a greater degree than other service business. Many large restaurant corporations stimulate employee turnover to lower benefit costs. These large corporations provide automated food preparation systems that allow untrained employees to execute meal preparations while maintaining a high level of food quality. Therefore, the restaurant industry is harder for labor unions to organize.

The IRO System creates the potential for life-long employment because employees are assigned customers with whom they can build lifetime relationships. There are long term benefits in both completeness and accuracy of records when employees, rather than management control the customer database.

The greatest incentive for life-long employment is employee satisfaction. The restaurant business is one of many hospitality businesses through which customer needs are satisfied by product and service fulfillment. The industry attracts employees who enjoy interacting with and satisfying the desires of other people. Through the IRO System, long term employee satisfaction is created not only by the enjoyment of such work, but also by stock ownership and other incentives. A positive working environment in which employees are both empowered and are provided incentives to manage themselves, when coupled with a program of points, rewards, stock ownership, could lead to better retention of quality employees and a greater financial return for restaurants that use the IRO System.

### Definitions

The term “Related Work” refers to the Integrated Service System: Enhancement incentive system using transaction events for rewards on a distributed network. A patent application Ser. No. 09/898,686.

An Integrated Restaurant Operating (IRO) System empowering restaurant employees through the use of:

A restaurant reservation system accessed via the Internet by both customers and employees. An assigned employees responds to reservation requests and inquires from customers, both in person at the point of sale and from remote computer terminals using ID codes. The IRO System's is supported by the Integrated Service System (ISS) of patent Ser. No. 09/898,868 wherein the ISS has a server under the control of software using a database, email, auction and scheduler.

The “Customer Subscription Agreement” is a binding contract. Its purpose is to bind the customer to the rules of the Sponsored Company. The terms and conditions are the membership requirements. The customer agrees to provide the information needed to allow the issuance of points, units and equity and/or the exchange of points, units and equity. The Agreement is inclusive and the points and equity exchanges are exclusive and can only be exchanged within the Sponsored Company's Point Auction, which said action is in the Related Work. Points and equity can not be transferred or sold without the approval of the Sponsored Company, and in accordance with the laws governing securities and restricted shares. The Customer Subscription Agreement provides a profile wherein the customer is requested to provide identification, demographic information and preferences for the Sponsored Company's customer relationship program.

A Customer Relationship Manager (CRM) is a database for employees and customers that contains both the Employee File Manager (EFM) and the Customer File Manager (CFM). The CRM provides employees with the ability to communicate with assigned customers. The employee is required to update the Customer File Manager (CFM) after each contact with the customer. He or she will, in that process, suggest and store the next customer greeting, add new information about preferences and other pertinent comments to the file as well as other specific word search requirements.

An Integrated Restaurant Operating System (IRO) empowers employees to manage service operations.

“Standard” is defined as stated customer and employee profile, policies, and procedures.

“Upman” is a tile of a senior employee whose responsibility is deciding any daily problems and conflicts within a work shift.

“Variance” is the degree of difference with a profile, policy, requirement wherein the Sponsored Company may require the profile, event to be recorded as a change therefore the variance is significant. Variance is the fact or state of being in disagreement, a disagreement between two parts of the same stated proceeding that must be consonant. The invention uses variance from stated Sponsored Company events using stated standards.

“Variance Report” is defined as a standard work condition, which is best practice and the “change” from the standard or best practice is identified. A bartender can report a wine bottle whose cork has been opened and the wine has been damaged or a broken beer bottleneck. A Kitchen employee could report lower or greater yields on beef filet loin wherein the portion cost is significant and the portion cost can be change. A waitperson can report a change in the customer preferences on menu timing, placement and ordering.

### DETAIL DESCRIPTION OF THE DRAWINGS

FIQ. 1 is a schematic block diagram illustrating the different modules controlled by the Server.

FIQ. 2 is a schematic block diagram illustrating the Employee Event Module.

FIQ. 3 is a schematic block diagram illustrating the Upman Event Module.

FIQ. 4 is a schematic block diagram illustrating the Customer Event Module.

FIQ. 5 is a schematic block diagram illustrating the Customer Relationship Module.

FIQ. 6 is a schematic block diagram illustrating the Server Application Modules.

### DESCRIPTION OF THE PREFERRED EMBODIMENT

In this section, the present invention is described in detail with regard to the drawing described in Detail Description of the Drawings. Terms used throughout the remainder of this section are used with the meanings under Definitions.

The following paragraphs illustrate the structural and operational aspects of the preferred embodiment of the present invention.

FIQ 1 shows a diagram of the system for user incentive transaction event. The system uses technology from patent Ser. No. 09/898,686.

In FIQ 1, the system using a Host Computer 100, which is the preferred embodiment of the invention, the system is an IBM PC compatible operating the Microsoft Windows XP operating system, and the Server System 150 configured as a Web Server providing access. The Host Computer 100 software using Netscape Communicator or Microsoft Internet Explorer, the PC is capable of accessing the system, which is composed of web pages, which is well known in the art.

Preferably the communication channel 110 is TCP/IP based network such as the Internet or an intranet, although almost any well known LAN, WAN, VPN technology can be used. Users can exchange messages with enclosures such as files, graphics, video and audio. The system also supports multiple languages. Alternatively, the network interface may be configured as voice and voice over IP.

The System Server 150 is typically Web server hardware and it can range from a high end PC to racks of multiprocessor, high-end computer system optimized for the task. Web server software can be Microsoft Internet Information Server, Sun Fire and Enterprise Server, IBM Websphere.

FIQ. 1 describes the system providing the user the access using a Host Computer 100 by a user Identification Profile 500 wherein the user has been authenticated by the Server 150. Authentication is the verification of a user's claimed identity, through which the user logs into the system which is well known in the art. A password is the preferred embodiment where the user can access the system. The user has a Public Key Identification (PKI) that is stored on a server database. The user PKI includes the subscription agreement which includes the users name, address, phone number, email address, inception date and user classification. There are authentication structures as Pretty Good Privacy, X.500, x.509 and someone well know in the art can appreciate other methods and systems.

The server under the control of software components creates transaction events for reward enhancement. The transaction events are user requirements based upon a user subscription agreement which the agreement requirements define user incentives. An Employee Event Module 205, Upman Event Module 210, Customer Event Module 230, and Customer Relationship Module 240.

The user is provided an Identification Profile (ID) 500 upon the an operational or transaction event and by executing the user subscription agreement.

FIQ. 2 is a block diagram of the Employee Event Module wherein the employee using an ID enters the IRO System and his ID is matched the Unit's schedule 206. The Work Order Assignment 207 is posted wherein the employee confirms the assignment. The Work Order Assignment is completed during the work shift and the employee reports any variance in the assignment 208 and if significant to the Upman Event Module 210. The user ends his work shift by exiting the IRO System 209 and the employee using the system has created a transaction event 580 wherein the event has generated points. The event is recorded and it is stored in the database 200. The ID is updated.

FIQ. 3 is a block diagram of the Upman Event Module wherein the Upman using an ID enters the IRO System and his ID is matched by the Unit's schedule 206. The Work Order Assignment 207 is posted wherein the Upman confirms the assignment. The Upman reviews and confirms the Unit variances wherein the variances are identified and confirmed changes and he or she records the changes in the IRO System file and database 200, 225. The ID is updated

FIQ. 4 is a block diagram of the Customer Event Module wherein the customer using an ID enters the IRO System. The ID queries a greeting which the greeting is displayed using the Customer Relationship Module 240. The Purchase Event 520 is a transaction wherein the ID, Narne, Date and Point Award, Salutation are known to the customer by print or display 241. The Purchase Event is referenced in patent application Ser. No. 09/898,868 wherein the event has a said amount and a ratio. The Customer Outcome 241 is recorded and any change is recorded in the database 225. The ID is updated.

FIQ. 5 is a block diagram of the Customer Relationship Module 240 wherein the customer greeting, preferences, and customer profile are available to the employee. The profile is taken from the Subscription Agreement Profile 510. The Profile is customer information taken from the Subscription Agreement 505. The Profile has an inception date that is part of the ID profile 500. The Customer Relationship Module 240 represents a description of the customer and the assigned employee wherein the description is updated by transaction events, and by employee entries which include descriptions of greetings, and preferences 240. The ID profile is a related work in patent application Ser. No. 09/898,868.

FIQ. 6. Is a block diagram of the Server Application Module wherein the IRO System under the control of software components uses a Reservation Package (ProHost) 700, Information Board (Welcome Board) ProHost 710, Menu Board Module; Hospitality Solutions Inc. 720, Table Seating Module; Hospitality Solutions Inc. 730, Service Status Board; NCR and Hospitality Solutions Inc. 740, Cash Bank Module; Hospitality Solutions Inc. 750. The Server Application Module uses these applications which said applications are well know in the art.

The IRO System is controlled by software component using existing application for reserving customer request by a Reservation Package and using existing applications under the control of a Information Board, Table Seating Module, Service Status Board and a Cash Bank. IRO System using applications under the control of software components provide the Sponsored Company use of the invention modules of the Employee Event Module 205, Upman Module 210, Customer Event Module 220, and Customer Relationship Module 240. The IRO system uses variance wherein an event having a variance from the standard has been identified and if the event is significant, the event is reported as a change. The employee serving customers, producing, supplying and maintaining the food service operations report any variance within their work shift.

The customer is measured by his purchases, and preferences and the employee updates the Customer Relationship Manager.

1. A system using transaction events to generate user information:
a host computer for transmitting a user identification profile:
a server computer under the control of software components, wherein the components comprise:
an event module for generating change based upon an employee or customer variance.

2. The system of claim 1, wherein the assignment, preference, and profile identifies the standard.

3. The system of claim 1, wherein the database comprises two databases the Employee File Manager and Customer File Manager.

4. The system of claim 1, comprises a Customer Relationship Manager wherein the customer greeting, preferences and profile are changed.

5. The system of claim 3, further comprises a subscription agreement wherein the agreement provides identification, preferences and profile.

6. The system of claim 1, provides a Reservation Package, Information Board, Menu Board, Table Seating Module, Service Status Board, and Cash Bank.
